(19) United States
(12) Patent Application Publication
(10) Pub. No.: US 2014/0277730 A1
(43) Pub. Date: Sep. 18, 2014

(54) POSITION DETECTION APPARATUS, LENS APPARATUS, IMAGE PICKUP SYSTEM, AND MACHINE TOOL APPARATUS

(71) Applicant: CANON KABUSHIKI KAISHA, Tokyo (JP)

(72) Inventor: Hitoshi Nakamura, Kawasaki-shi (JP)

(73) Assignee: CANON KABUSHIKI KAISHA, Tokyo (JP)

(21) Appl. No.: 14/208,321

(22) Filed: Mar. 13, 2014

(30) Foreign Application Priority Data
Mar. 15, 2013 (JP) 2013-052747

(51) Int. Cl. G01D 5/347; B25J 13/08

(52) U.S. Cl. CPC G01D 5/3473; B25J 13/088; Y10S 901/09
USPC 700/258; 250/231.18; 250/208.1; 901/9

(57) ABSTRACT

A position detection apparatus (100) includes a scale (10) including a pattern circumferentially and periodically formed on a circle whose center is a predetermined point, a sensor unit (20) relatively movable with respect to the scale (10), and a signal processor (40) which processes an output signal of the sensor unit (20) to obtain position information of an object, and the sensor unit (20) includes a first detector (21) and a second detector (22), and the signal processor (40) reduces an error component contained in the position information due to a difference between a rotation center of the scale (10) and the predetermined point based on a first detection signal outputted from the first detector (21) and on a second detection signal outputted from the second detector (22).

### BACKGROUND OF THE INVENTION

1. Field of the Invention

The present invention relates to a position detection apparatus (an encoder) which detects a position.

2. Description of the Related Art

Conventionally, rotary encoders (position detection apparatuses) have been known which detect a position (a rotational displacement) of an object by reading a predetermined pattern of a scale attached to a rotational shaft of the object and configured to rotate corresponding to a rotation of the object. In the rotary encoder, when a rotation center and a pattern center of the scale are shifted to each other, a periodic error (an eccentric error) having characteristics of a sinusoidal wave with one period per rotation occurs.

Japanese Patent Laid-Open No. (“JP”) 6-58771 discloses a position detection apparatus which includes two sensors arranged at positions different by 180 degrees from each other with respect to a rotational shaft and corrects an eccentric error by averaging signals obtained from the two sensors.

The position detection apparatus disclosed in JP 6-58771 can correct the eccentric error to improve detection accuracy. However, it requires the two sensors to be arranged at positions shifted by 180 degrees from each other with respect to the rotational shaft. This leads to an increase in the size of holding members of the sensors, which prevents miniaturization of the position detection apparatus.

### SUMMARY OF THE INVENTION

The present invention provides small-sized and highly-accurate position detection apparatus, lens apparatus, image pickup system, and machine tool apparatus.

A position detection apparatus as one aspect of the present invention is configured to detect a position of an object, and includes a scale which includes a pattern circumferentially and periodically formed on a circle whose center is a predetermined point, the scale being configured to rotate depending on a displacement of the object, a sensor unit relatively movable with respect to the scale, and a signal processor configured to process an output signal of the sensor unit to obtain position information of the object, the sensor unit includes a first detector configured to detect a first partial pattern formed in a first region apart from the predetermined point by a first distance in a radial direction on a half line starting from the predetermined point of the scale, and a second detector configured to detect a second partial pattern formed in a second region apart from the predetermined point by a second distance different from the first distance, and the signal processor is configured to reduce an error component contained in the position information due to a difference between a rotation center of the scale and the predetermined point based on a first detection signal outputted from the first detector and on a second detection signal outputted from the second detector.

A lens apparatus as another aspect of the present invention includes a lens displaceable in an optical axis direction, and the position detection apparatus.

An image pickup system as another aspect of the present invention includes the lens apparatus and an image pickup apparatus including an image pickup element configured to perform a photoelectric conversion of an optical image formed via the lens.

A machine tool apparatus as another aspect of the present invention includes a machine tool including at least one of a robot arm and a conveyer configured to convey an object to be assembled, and the position detection apparatus configured to detect at least one of a position and an attitude of the machine tool.

Further features and aspects of the present invention will become apparent from the following description of exemplary embodiments with reference to the attached drawings.

### BRIEF DESCRIPTION OF THE DRAWINGS

FIG. 1 a schematic configuration diagram of an encoder (a position detection apparatus) in a first embodiment.

FIG. 2 is a diagram illustrating a cross section (the position relationship between a sensor and a scale) of the encoder in the first embodiment.

FIGS. 3A and 3B are configuration diagrams of light receiving portions in the first embodiment and a third embodiment.

FIG. 4 is a block diagram of a signal processor in the first embodiment.

FIG. 5 is a relationship diagram of a rotation angle of the scale and an error in the first embodiment.

FIG. 6 is a diagram illustrating the position relationship between the sensor and the scale in the first embodiment.

FIG. 7 is a relationship diagram of a rotation angle of the scale and an error in the first embodiment.

FIG. 8 is a block diagram of a signal processor in a second embodiment.

FIG. 9 is a schematic configuration diagram of an encoder (a position detection apparatus) in the third embodiment.

FIG. 10 is a block diagram of a signal processor in the third embodiment.

FIGS. 11A to 11D are relationship diagrams of a rotation angle of a scale and an error in the third embodiment.

FIG. 12 is a schematic configuration diagram of an image pickup apparatus (an image pickup system) in a fourth embodiment.

### DESCRIPTION OF THE EMBODIMENTS

Exemplary embodiments of the present invention will be described below with reference to the accompanied drawings. In the drawings, the same elements will be denoted by the same reference numerals and the descriptions thereof will be omitted.

### First Embodiment

First of all, referring to FIGS. 1 and 2, an encoder (a position detection apparatus) in a first embodiment of the present invention will be described. FIG. 1 is a schematic configuration diagram of an encoder 100 in the first embodiment. FIG. 2 is a diagram illustrating a cross section (the position relationship between a sensor and a scale) of the encoder 100. The encoder 100 is a position detection apparatus which detects a position (a displacement) of an object, and is especially a reflection-type optical incremental encoder.

As illustrated in FIG. 1, the encoder 100 includes a scale 10, a sensor 20, and a signal processor 40. The scale 10 includes a pattern circumferentially and periodically formed on a circle whose center is a predetermined point (a pattern center, or a rotation center of the scale 10), and the scale 10 rotates depending on a displacement of the object. The scale 10 is attached to a rotational shaft 30 (a rotational shaft of an object to be measured). The sensor 20 (a sensor unit) is attached to a fixed member (not illustrated in the drawing), and is relatively movable with respect to the scale 10. Such a configuration enables the sensor 20 to detect a rotation angle of the rotational shaft 30 (a relative angle between the scale 10 and the sensor 20).

On the scale 10, a track 11 (a pattern) having a reflection portion (a black portion in FIG. 1) and a non-reflection portion (a white portion in FIG. 1) is formed. As illustrated in FIG. 2, the sensor 20 includes two light receiving portions 21 and 22 and a light source 23. FIG. 2 illustrates the position relationship between the scale 10 and the sensor 20 as seen from a direction vertical to the rotational shaft 30. Light emitted from the light source 23 is reflected by the reflection portion of the track 11, and then reaches the light receiving portion 21 (a first detector) and the light receiving portion 22 (a second detector).

A position of light reaching the track 11 of paths from the light source 23 to the light receiving portions 21 and 22 is a read position on the track 11. Hereinafter, a length (distance) from a pattern center O of the track 11 to a read position of the track 11 is referred to as a “detection radius”. As illustrated in FIG. 2, detection radii of the paths from the light source 23 to the light receiving portions 21 and 22, i.e. radii (distances) in a radial direction on a half line starting from a predetermined point (a pattern center O) of the scale 10, are denoted by symbols r1 and r2, respectively. As described above, the sensor 20 (the sensor unit) of this embodiment includes the light receiving portion 21 (the first detector) configured to detect the pattern (a first partial pattern) formed in a region (a first region) apart from the pattern center O by a first distance (a radius r1) in the radial direction on the half line starting from the predetermined point of the track 11. The sensor 20 further includes the light receiving portion 22 configured to detect the pattern (a second partial pattern) formed in a region (a second region) apart from the pattern center O by a second distance (a radius r2) different from the first distance (the radius r1).

Each of the light receiving portions 21 and 22 includes a plurality of light receiving elements arrayed in a length measurement direction (a direction orthogonal to a plane of paper of FIG. 2). A displacement of a relative position between the scale 10 and the sensor 20 causes an intensity of light reflected by each light receiving element to be changed depending on an amount of the displacement. The sensor 20 outputs, for each of the light receiving portions 21 and 22, the intensity of each of respective reflected lights as a two-phase false sinusoidal signal.

FIG. 3B is a schematic configuration diagram of the light receiving portions 21 and 22. In this embodiment, as illustrated in FIG. 3B, each four adjacent outputs of the light receiving elements is classified into four types as A(+), B(+), A(−), and B(−). Based on expressions of A=A (+)−A (−) and B=B (+)−B(−), two-phase false sinusoidal signals A and B are output. Where a pattern period of the track 11 is λ and a width of each light receiving element in an angle detection direction (a length measurement direction) is d, the relation of 2λ≈4d is satisfied because an image of the pattern of the track 11 is magnified two-fold on each light receiving element.

Subsequently, referring to FIG. 4, the signal processor 40 in this embodiment will be described. FIG. 4 is a block diagram of the signal processor 40. The signal processor 40 processes the output signals of the sensor 20 to obtain position information of the object. In addition, as described later, the signal processor 40 is configured to reduce an eccentric error (an error due to eccentricity) of the scale 10 contained in the position information of the object based on a first detection signal outputted from the light receiving portion 21 (the first detector) and a second detection signal outputted from the light receiving portion 22 (the second detector). In this embodiment, the “eccentric error” means a difference (a difference in position) between the predetermined point (the pattern center O) and a rotation center of the scale 10, that is, an error which is generated when there is a displacement (an eccentricity) between the predetermined point and the rotation center of the scale 10. Although a description is given in this embodiment using the expression “virtually reduces the eccentric error”, the signal processor 40 does not actually reduce the eccentric error, but reduces an error component generated by the eccentric error contained in the position information. As a result, an effect is obtained that the same or similar position information as that obtained when position detection is performed with the eccentric error being reduced (or being eliminated) can be obtained.

As illustrated in FIG. 4, the signal processor includes an A/D converter 41, a phase detection processing unit 42, an angle detection processing unit 43, an eccentricity detection processing unit 44, and an angle correction processing unit 45. In this configuration, the signal processor 40 detects an angle (a displacement) in which the eccentric error has been corrected, based on the output signals of the sensor 20.

Subsequently, an angle detection operation of the signal processor 40 will be described. First, the A/D converter 41 samples two pairs of two-phase sinusoidal signals (analog signals) corresponding to the light receiving portions 21 and 22 to convert them to digital signals. Then, the phase detection processing unit 42 performs an arc-tangent calculation with respect to the sampled two pairs of two-phase sinusoidal signals (the digital signals) to determine a phase. Since a two-phase sinusoidal signal is equivalent to a sine signal “sin” and a cosine signal “cos”, a phase can be determined by performing an arc-tangent calculation. A description will be given below, with phases (the first detection signal and the second detection signal) corresponding to the light receiving portions 21 and 22 being denoted as θ1 and θ2, respectively.

The angle detection processing unit 43 (the position detection processing unit) detects an angle based on the phase θ1 determined by the phase detection processing unit 42. The phase θ1 continuously changes from 0 to 2π for each pair of the reflection portion and the non-reflection portion of the track 11, and then transitions from 2π to 0 immediately before the angle detection processing unit 43 starts reading signals from a subsequent pair of the reflection portion and the non-reflection portion. The angle detection processing unit 43 calculates an amount of phase change (an amount of phase shift) by detecting the transition to determine the angle based on the amount of phase change.

For instance, a case will be described in which the track 11 has 90 periods in 360 degrees, that is, the shift of the phase 2n is equivalent to four degrees. In this case, assuming that an initial phase of n/2 becomes 3π/2 after it transitions by two periods in a direction in which an angle increases, a total of phase change of 5π occurs, and thus it can be determined that the phase change is equivalent to an angle of 20 degrees by converting the phase to an angle. More generally, the amount of phase change can be determined by detecting a phase at fixed intervals and then accumulating a difference between a latest phase and a phase detected immediately before detecting the latest phase. A phase change amount s(i) observed at the i-th time detection of the phase θi as a phase change amount up to that time is represented by the following Expression (1), where the relationships of s(0)=0 and θ(0)=0 are satisfied and symbol i denotes a natural number.

s(i)=s(i−1)+(0(i)−θ(i−1)) (1)

Then, the angle detection processing unit 43 converts the phase change amount s(i) to an angle (a position) depending on the period of the track 11. Where symbol k denotes the ratio of a period and an angle of the track 11, the angle is represented as k·s(i). As described above, the angle detection processing unit 43 (a position detection processing unit) obtains position information of the object based on the first detection signal outputted from the light receiving portion 21.

The eccentricity detection processing unit 44 (an eccentric error calculating unit) calculates an error e1 contained in the phase θ1 by using detection radii r1 and r2 and the phases θ1 and θ2. Referring now to FIG. 5, a description will be given of an error contained in a detected angle corresponding to the light receiving portions 21 and 22 where ε denotes an eccentric amount. FIG. 5 is a relationship diagram of a rotation angle of the scale 10 and an error. In FIG. 5, a dotted line (A) indicates an error contained in an angle obtained by the light receiving portions 21 and a solid line (B) indicates an angle obtained by the light receiving portions 22. A dashed line (C) indicates a difference between the dotted line (A) and the solid line (B).

In this embodiment, radii (detection radii) corresponding to the light receiving portions 21 and 22 are r1 and r2, respectively. Angles of the read positions on the track 11 for the light receiving portions 21 and 22 are equal to each other with reference to the rotational shaft 30. Accordingly, maximum values of detection errors caused by the light receiving portions 21 and 22 are ε/r1 and ε/r2, respectively. The relationship between a rotation angle and a detection error includes an error profile having the same phase within one period for one rotation of the scale 10. Where an error contained in a detected angle is e when a detection radius is r and an eccentricity is ε, the error e is represented by the following Expression (2). In Expression (2), symbol α is a constant.

e=(ε/r)·sin(θ+α) (2)

The difference indicated by the dashed line (C) in FIG. 5 can be obtained by determining a difference between the two errors, that is, a difference θ1−θ2 between the phase θ1 and the phase θ2 corresponding to the light receiving portions 21 and 22, respectively. In this case, the difference θ1−θ2 is represented by the following Expression (3) by using Expression (2).

θ1−θ2=(ε/r1−ε/r2)·sin(θ+α) (3)

The difference indicated by the dashed line (C) also has an error profile in which its phase is the same as that of each of the dotted line (A) and the dotted line (B) and its amplitude is different from that of each of the dotted line (A) and the dotted line (B). The ratio of an amplitude indicated by the dotted line (A) and an amplitude indicated by the dotted line (B) depends only on the detection radii r1 and r2. Therefore, the error e1 (the eccentric error) can be calculated as represented by the following Expression (4).

e1=(ε/r1)·sin(θ+α)=(θ1−θ2)·(r2/(r2−r1)) (4)

As described above, the eccentricity detection processing unit 44 (the eccentric error calculating unit) calculates an eccentric error based on the first detection signal outputted from the light receiving portion 21, the second detection signal outputted from the light receiving portion 22, the radius r1 (the first distance), and the radius r2 (the second distance).

The angle correction processing unit 45 (a position correcting unit) subtracts the error e1 determined by the eccentricity detection processing unit 44 from the angle k·s(i) determined by the angle detection processing unit 43 to determine a corrected angle (an angle in which an eccentric error has been reduced). In other words, the angle correction processing unit 45 (the position correcting unit) subtracts the eccentric error calculated by the eccentricity detection processing unit 44 from the position information obtained by the angle detection processing unit 43 to obtain corrected position information. As a result, the signal processor 40 of this embodiment can reduce the error (the eccentric error) to detect the angle with higher accuracy.

While, in this embodiment, the angles of the read positions on the track 11 by the light receiving portions 21 and 22 are equal to each other relative to the rotational shaft 30, this embodiment is not limited to this. Even when the read positions on the track 11 by the light receiving portions 21 and 22 are different from each other (even when the angles are different from each other), a relative offset amount between the rotation angle detected by the light receiving portion 21 and the rotation angle detected by the light receiving portion 22 which is caused by a relative displacement amount between the detected angles with respect to the eccentricity can be specified. For this reason, an eccentric error correction can be performed even in this case.

For instance, a case will be described in which, as illustrated in FIG. 6, the scale 10 and the sensor 20 has a rotational inclination between them with respect to an axis passing through the light source 23 in parallel to the rotational shaft 30 (when there is an angle difference φ between the scale 10 and the sensor 20). In this case, read positions corresponding to the light receiving portions 21 and 22 are shifted from those appearing when they do not have the rotational inclination.

FIG. 7 is a relationship diagram of a rotation angle of the scale 10 and an error which are observed when there is a rotational inclination as illustrated in FIG. 6. In FIG. 7, a dotted line (A) indicates an error contained in a detected angle obtained by the light receiving portion 21, and a dotted line (B) indicates an error contained in a detected angle obtained by the light receiving portion 22. As illustrated in FIG. 7, error profiles of the phases θ1 and θ2 contain offset amounts c1 and c2 respectively, corresponding to a shift amount of the read positions in a circumferential direction (a length measurement direction). Where φ is an angle difference between read positions corresponding to the light receiving portions 21 and 22, the relationship of φ=c1−c2 is satisfied. The error profiles of the phases θ1 and θ2 are represented by the following Expressions (5) and (6), as in the case of Expression (2).

(ε/r1)·sin(θ+α1)+c1 (5)

(ε/r2)·sin(θ+α2)+c2 (6)

In Expressions (5) and (6), since a shift amount of the detected positions in the circumferential direction due to the inclination of the sensor 20 is sufficiently small compared to the detection rotation angle, the relationship of α1≈α2 is satisfied. Therefore, a difference θ1−θ2 between the phases θ1 and θ2 is approximated as represented by the following Expression (7). A phase error corresponding to the light receiving portion 21 can be determined by the following Expression (8).

θ1−θ2≈(ε/r1−ε/r2)·sin(θ+α1)+φ (7)

(ε/r1)·sin(θ+α)=(θ1−θ2−φ)·(r2/(r2−r1)) (8)

If there is an alignment error between the scale 10 and the sensor 20, a term (an angle difference φ) to be an average value of a maximum value and a minimum value of Expression (7) has a value other than zero. In this embodiment, the determination of this amount (the angle difference φ) allows the detection and the correction (the reduction) of a shift amount of read positions, that is, an alignment shift. As described above, the signal processor 40 is further capable of reducing a difference (difference in position) between a region (a first region) of the radius r1 (the first distance) and a region (a second region) of the radius r2 (the second distance) in the length measurement direction that is a direction vertical to the radial direction of the scale 10. This difference is an error caused by a position shift between the regions of the radii r1 and r2 in the circumferential direction. The use of the term (ε/r1−ε/r2)·sin(θ+α1) in Expression (7) derived as a term which satisfies the relationship of α1≈α2 allows the detection of the eccentric amount to correct (reduce) the eccentric error.

### Second Embodiment

Next, referring to FIG. 8, an encoder (a position detection apparatus) in the second embodiment of the present invention will be described. FIG. 8 is a schematic configuration diagram of a signal processor 40a of the encoder in this embodiment. The signal processor 40a is different from the signal processor 40 of the first embodiment in that it uses a correction table to correct detected positions, that is, to reduce an eccentric error. Thus, as illustrated in FIG. 8, the signal processor 40a includes a correction table 46 (a corrected value storage unit).

The correction table 46 previously stores a plurality of positions (position information), i.e., a plurality of detected angles, and a corrected value (a value to be used to reduce an eccentric error) corresponding to each position (position information). The angle correction processing unit 45 determines an angle in which an error (an eccentric error) has been corrected, i.e. corrected position information, based on the position information obtained by the angle detection processing unit 43, i.e. the angle (the detected angle) and the corrected value stored in the correction table 46.

Where j is an angle determined by the angle detection processing unit 43, c(j) is a corrected value corresponding to the angle j stored in the correction table 46, and x(j) is a corrected angle determined by the angle correction processing unit 45, the corrected angle x(j) can be determined as represented by the following Expression (9).

x(j)=j−c(j) (9)

In this embodiment, the corrected value can be stored in the correction table 46 by storing the combination of the angle j detected by the angle detection processing unit 43 and the error e (the corrected value c(j)) determined by the eccentricity detection processing unit 44. Furthermore, instead of storing all combinations of the angle j and its corresponding corrected value in the correction table 46, some values can be thinned (disregarded) without storing them. In this case, the corrected value c(j) corresponding to the angle may not exist. In order to cope with this situation, for instance, using corrected values c(k) and c(l) corresponding angles k and l (k<j<l) stored in the correction table 46, the angle correction processing unit 45 determines the corrected value c(j) corresponding to the angle j by linear interpolation to perform the correction as represented by the following Expression (10).

c(j)=(c(k)·(l−j)+c(l)·(j−k))/(l−k) (10)

A fitting to a function may be performed to reduce data volume to be stored in the correction table 46. An error e (an eccentric error) has one period per one rotation of the scale 10, and a detection radius r is constant. This makes it possible to approximately determine the error e as represented by the following Expression (11).

e=ε/r·sin(j+α) (11)

In this case, the correction table 46 needs only to store values of an eccentricity amount ε and a constant α.

### Third Embodiment

Next, referring to FIG. 9, an encoder (a position detection apparatus) in the third embodiment of the present invention will be described. FIG. 9 is a schematic configuration diagram of an encoder 100a in this embodiment. The encoder 100a is an absolute-type encoder (an absolute-type position detection apparatus) configured to detect a relative displacement (a relative position) between a scale 10a and a sensor 20.

As illustrated in FIG. 9, the scale 10a of this embodiment is provided with a track 12 (a first track) and track 13 (a second track). The tracks 12 and 13 are displaced in conjunction with each other with respect to the sensor 20. The track 12 has a grating pattern (a first pattern) with a pitch P1 (a first period) and a grating pattern (a second pattern) with a pitch P2 (a second period), and the pitches P1 and P2 are different from each other (the grating pattern with the pitch P1 and the grating pattern with the pitch P2 are multiplexed). The track 13 has a grating pattern (a third pattern) with a pitch Q1 (a third period) and a grating pattern (a fourth pattern) with a pitch Q2 (a fourth period), and the pitches Q1 and Q2 are different from each other (the grating pattern with the pitch Q1 and the grating pattern with the pitch Q2 are multiplexed).

The grating patterns of the track 12 have the pitch P1 of 544 periods per rotation and the pitch P2 of 128 periods per rotation. Similarly, the grating patterns of the track 13 have the pitch Q1 of 495 periods per rotation and the pitch Q2 of 132 periods per rotation. In this embodiment, the light receiving portions 21 and 22 detect a relative displacement between the scale 10a and the sensor 20 to classify outputs of the light receiving elements into four types of A (+), B (+), A (−), and B (−). Then, the light receiving portions 21 and 22 output two-phase false sinusoidal signals A and B by using the relationships of A=A (+)−A (−) and B=B (+)−B (−). In this embodiment, the sensor 20 has a function of selecting an array of the light receiving elements. This function enables the sensor 20 to selectively detect the pitches P1 and P2 and the pitches Q1 and Q2.

Subsequently, referring to FIGS. 3A and 3B, a method of reading a grating pattern of each pitch will be described. FIGS. 3A and 3B are configuration diagrams of the light receiving portions 21 and 22. FIG. 3A illustrates a relationship between the light receiving elements and their corresponding outputs observed when the grating pattern with the pitch P1 is read. In order to generate two-phase false sinusoidal signals orthogonal to each other when the grating pattern of the pitch P1 is read, a light receiving amount at a position shifted by P1/2 only has to be output. Therefore, as illustrated in FIG. 3A, each two adjacent outputs of the light receiving elements is arrayed in order of A (+), B (+), A (−), and B (−). Similarly, as illustrated in FIG. 3B, each four adjacent outputs of the light receiving elements is arrayed in order of A (+), B (+), A(−), and B (−) when the grating pattern of the pitch P2 is read. These configurations make it possible to output a two-phase false sinusoidal signal with each pitch.

The sensor 20 outputs intensities of reflected lights at certain positions on the light receiving portions 21 and 22 as signals. Therefore, even when a detection period of the sensor 20 and a period (a pitch) of each pattern formed on the scale 10a are slightly shifted to each other, the sensor 20 outputs a signal with a period corresponding to the pitch of the pattern formed on the scale 10a. Accordingly, where a detection period of the sensor 20 is P1, the light receiving portion 21 outputs a two-phase false sinusoidal signal with the pitch P1 and the light receiving portion 22 outputs a two-phase false sinusoidal signal with the pitch Q1. Similarly, where a detection period of the sensor 20 is 4×P1, the light receiving portion 21 outputs a two-phase false sinusoidal signal with the pitch P2 and the light receiving portion 22 outputs a two-phase false sinusoidal signal with the pitch Q2. As described above, the light receiving portion 21 (the first detector) detects (the pattern of) the track 12 and the light receiving portion 22 (the second detector) detects (the pattern of) the track 13.

Subsequently, referring to FIG. 10, an operation of a signal processor 40b in this embodiment will be described. FIG. 10 is a block diagram of the signal processor 40b. Since signals corresponding to four types of pitches of the tracks 12 and 13 are detected in this embodiment, the operation of the signal processor 40b is different from that of the signal processor 40 of the first embodiment and the signal processor 40a of the second embodiment.

First, the sensor 20 is configured to output two pairs of two-phase false sinusoidal signals corresponding to the patterns (the grating patterns) with the pitches P1 and Q1 included in the tracks 12 and 13, with the detection period of the sensor 20 being set to P1. Then, an A/D converter 41 samples the four signals. Subsequently, the A/D converter 41 samples the two pairs of two-phase false sinusoidal signals corresponding to the patterns with the pitches P2 and Q2 which are formed on the tracks 12 and 13, with the detection period of the sensor 20 being set to 4×P1.

The phase detection processing unit 42 determines four phases θP1, θQ1, θP2, and θQ2 based on the four pairs of two-phase false sinusoidal signals sampled by the A/D converter 41. Similarly to the first and second embodiments, the four phases θP1, θQ1, θP2, and θQ2 are determined by the arc-tangent calculation. An absolute-type detection processing unit 47 performs a vernier calculation with respect to the four phases θP1, θQ1, θP2, and θQ2 to determine an angle.

Subsequently, referring to FIGS. 11A to 11D, a relationship between an angle (a rotation angle) of the scale 10a and a phase will be described. FIGS. 11A to 11D are relationship diagrams of a rotation angle of the scale 10a and a phase. In FIGS. 11A to 11D, a horizontal axis indicates an angle and a vertical axis indicates a phase corresponding to the angle.

FIGS. 11A and 11B illustrate the phases θP1 and θP2. The phases θP1 and θP2 are phases corresponding to the pitches P1 and P2, which are formed on the track 12 with 544 periods per rotation and with 128 periods per rotation, respectively. Accordingly, the phase of the phase θP1 is approximately four times as long as that of the phase θP2. Thus, as represented by the following Expression (12), a phase signal θP3 is determined by multiplying the phase θP2 by four and then normalizing the value by 2π. Furthermore, as represented by the following Expression (13), a phase difference signal θP4 which is a phase difference between the phase θP1 and the phase θP3 is determined.

θP3=MOD(θP2×4,2π) (12)

θP4=MOD(θP1−θP3,2π) (13)

In Expressions (12) and (13), symbol MOD (x, y) denotes a residue of x divided by y. In this case, the phase signal θP3 and the phase difference signal θP4 are determined as illustrated in FIGS. 11C and 11D, respectively. Since the phase signal θP3 is obtained by quadrupling the phase θP2 with 128 periods per rotation, it is determined as a signal with 512 periods per rotation. The phase difference signal θP4 is determined as a signal with 32 periods per rotation that is a periodic difference between the signal with 544 periods per rotation and the signal with 512 periods per rotation.

The phase θP2 and the phase difference signal θP4 have 128 periods and 32 periods respectively, and on the other hand, the phase difference signal θP4 is a value calculated by multiplying the phase θP2 by four as represented by Expression (12). Therefore, the amount of error is also quadrupled, and thus the error contained in the phase difference signal θP4 is larger than that contained in the phase θP2. In order to cope with this, as represented by the following Expression (14), a signal θP5 with 32 periods which has the same accuracy as that of the phase θP2 is determined.

θP5=ROUND((4×θP4−θP2)/(2π)×2π/4+θP2/4 (14)

In Expression (14), symbol ROUND(x) denotes rounding off x to the nearest integer.

Similarly, with respect also to the phase θP1 with 544 periods and the signal θP5 with 32 periods, as represented by the following Expression (15), a signal θP6 with 32 periods which has the same accuracy as that of the phase θP1 is determined.

θP6=ROUND((17×θP5−θP1)/(2π))×2π/17+θP1/17 (15)

The phases θQ1 and θQ2 have 495 periods per rotation and 132 periods per rotation, respectively. Therefore, as represented by the following Expression (16), a phase signal θQ3 is determined by multiplying a phase θQ2 by four and then normalizing the value by 2π. Then, as represented by the following Expression (17), a phase difference signal θQ4 of the phase θQ1 and the phase signal θQ3 is determined. Furthermore, as represented by the following Expression (18), a signal θQ5 having the same accuracy as that of the phase θQ2 is determined. In addition, as represented by the following Expression (19), a signal θQ6 having the same accuracy as that of the phase θQ1 is determined.

θQ3=MOD(θQ2×4,2π) (16)

θQ4=MOD(θQ3−θQ1,2π) (17)

θQ5=ROUND((4×θQ4−θQ2)/(2π))×2π/4+θQ2/4 (18)

θQ6=ROUND((15×θQ5−θQ1)/(2π))×2π/15+θQ1/15 (19)

Since the signals θP6 and θQ6 have 32 periods per rotation and 33 periods per rotation respectively, a phase difference θ7 between the signals θP6 and θQ6 is determined as represented by the following Expression (20).

θ7=MOD(θQ6−θP6,2π) (20)

The phase difference θ7 represents an angle since it is a signal with a period per rotation that is a periodic difference between the signal with 32 periods per rotation and the signal with 33 periods per rotation. The phase difference θ7, however, has a larger error compared with that of each of the signals θP6 and θQ6. In order to cope with this, signals θP8 and θQ8 which have the same accuracy as those of the signals θP6 and θQ6 are determined as represented by the following Expressions (21) and (22), respectively. Each of the signals θP8 and θQ8 is a signal with one period per rotation, which represents an angle.

θP8=ROUND((32×θ7−θP6)/(2π))×2π/32+θP6/32 (21)

θQ8=ROUND((33×θ7−θQ6)/(2π))×2π/33+θQ6/33 (22)

The eccentricity detection processing unit 44 determines an eccentric error based on the signals θP8 and θQ8. Since the signals θP8 and θQ8 represent angles, the relationship of θP8=θQ8 is satisfied when they do not have an eccentricity, and on the other hand, an error depending on the eccentricity is contained when they have the eccentricity. A difference θP8−θQ8 between the signal θP8 and the signal θQ8 is represented by the following Expression (23) as in the case of Expression (3).

θP8−θQ8=(ε/r1−ε/r2)sin(θ+α) (23)

In Expression (23), it can be assumed that the signal θP8 corresponding to the light receiving portion 21 contains an error represented by the following Expression (24). The eccentricity detection processing unit 44 calculates this error.

ε/r1·sin(θ+α)=(θP8−θQ8)(r2/(r2−r1)) (24)

The angle correction processing unit 45 determines an angle in which the error (the eccentric error) determined by the eccentricity detection processing unit 44 is subtracted from the signal θP8. This series of operations allows the determination of an error-corrected position (an error-reduced position).

The encoder 100a of this embodiment is an absolute position detection apparatus capable of detecting an absolute position. “Absolute position” used in this embodiment means a relative position of a pattern (or an object to be measured having the pattern thereon) with respect to a detector (the sensor unit) or a relative position of a moving object to be measured with respect to a fixed part. The absolute position detection apparatus is an apparatus capable of detecting a relative position (“absolute position” used in this embodiment) between them in a measurement performed by the detector. On the other hand, the encoders of the first and second embodiments, which are different from the absolute-type position detection apparatus as described in this embodiment, are incremental type encoders capable of detecting only a position shift (change of a position) in a measurement by the detector. An incremental-type position detection apparatus is capable of determining an absolute position based also on a detection result of an origin detection apparatus (an apparatus capable of uniquely determining a relative position) separately provided.

In this embodiment, as in the case of the first embodiment, when the read positions of the light receiving portions 21 and 22 are shifted on the track 11, an offset amount occurs in Expression (23). In order to cope with this, the encoder 100a may be configured to detect and correct the offset amount. Alternatively, a correction table may be used to correct an error as in the case of the second embodiment.

### Fourth Embodiment

Next, referring to FIG. 12, the fourth embodiment of the present invention will be described. This embodiment relates to a lens apparatus (a lens barrel) including the encoder (the position detection apparatus) in each of the embodiments described above. FIG. 12 is a schematic configuration diagram of an image pickup apparatus (an image pickup system) in this embodiment.

In FIG. 12, reference numeral 51 denotes a lens unit, reference numeral 52 denotes a drive lens (a lens), reference numeral 53 denotes a sensor unit, reference numeral 54 denotes a CPU, and reference numeral 55 denotes an image pickup element. The sensor unit 53 corresponds to the sensor 20 of each of the embodiments described above. The CPU 54 corresponds to the signal processor of each of the embodiments (each of the signal processors 40a, 40b, and 40c). The position detection apparatus (the encoder) is configured to detect a position (a displacement) of the drive lens 52. The image pickup element 55 photoelectrically converts an object image (an optical image) formed via the lens unit 51 (the drive lens 52). The lens unit 51, the sensor unit 53, and the CPU 54 are provided in the lens apparatus (the lens barrel), and the image pickup element 55 is provided in a body of the image pickup apparatus. As described above, the lens apparatus of this embodiment is configured to be interchangeable with respect to the body of the image pickup apparatus. This embodiment, however, is not limited to this, and is also applicable to an image pickup apparatus (an image pickup system) which is integrally configured by the lens apparatus and the body of the image pickup apparatus.

The drive lens 52 constituting the lens unit is, for example, a focus lens for auto focus and displaceable in a Y direction that is a direction toward an optical axis OA (an optical axis direction). The drive lens 52 may be other drive lenses such as a zoom lens. A cylindrical body 50 (a movable portion) of the position detection apparatus in each of the embodiments described above is connected to an actuator (not illustrated in the drawing) configured to drive the drive lens 52. A rotation of the cylindrical element 50 around the optical axis OA by the actuator or by hand causes the scale 10 to be relatively displaced with respect to the sensor unit 53. This relative displacement causes the drive lens 52 to be driven in the Y direction (an arrow direction) that is the optical axis direction. A signal (an encoder signal) depending on a position (a displacement) of the drive lens 52 obtained from the sensor unit 53 of the position detection apparatus (the encoder) is output to the CPU 54. The CPU 54 generates a drive signal to move the drive lens 52 to a desired position, and the drive lens 52 is driven based on the drive signal.

The position detection apparatus of each embodiment is also applicable to various kinds of apparatuses other than the lens apparatus or the image pickup apparatus. For instance, a machine tool apparatus can be configured by a machine tool including a movable member such as a robot arm or a conveyer to convey an object to be assembled, and the position detection apparatus of each embodiment which detects a position or an attitude of the machine tool. This enables highly-accurate machining by detecting a position of the robot arm or the conveyer with high accuracy.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment (s) of the present invention, and by a method performed by the computer of the system or apparatus by, for example, reading out and executing the computer executable instructions from the storage medium to perform the functions of one or more of the above-described embodiments. The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to each of the embodiments described above, since a plurality of sensors can be adjacently arranged in the radial direction in order to correct an eccentric error, holding members of the sensors can be miniaturized. Moreover, when necessary, a tilt of each sensor (an attachment tilt of each sensor with respect to a direction toward a half line starting from a pattern center) can be detected and corrected. Thus, according to each embodiment, small-sized and highly-accurate position detection apparatus, lens apparatus, image pickup system, and machine tool apparatus can be provided.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-052747, filed on Mar. 15, 2013, which is hereby incorporated by reference herein in its entirety.

What is claimed is:

1. A position detection apparatus which detects a position of an object, the position detection apparatus comprising:
a scale which includes a pattern circumferentially and periodically formed on a circle whose center is a predetermined point, the scale being configured to rotate depending on a displacement of the object;
a sensor unit relatively movable with respect to the scale; and
a signal processor configured to process an output signal of the sensor unit to obtain position information of the object,
wherein the sensor unit comprises:
a first detector configured to detect a first partial pattern formed in a first region apart from the predetermined point by a first distance in a radial direction on a half line starting from the predetermined point of the scale; and
a second detector configured to detect a second partial pattern formed in a second region apart from the predetermined point by a second distance different from the first distance, and
wherein the signal processor is configured to reduce an error component contained in the position information due to a difference between a rotation center of the scale and the predetermined point based on a first detection signal outputted from the first detector and on a second detection signal outputted from the second detector.

2. The position detection apparatus according to claim 1, wherein the signal processor is configured to further reduce a difference between the first region apart by the first distance and the second region apart by the second distance in a circumferential direction of the scale.

3. The position detection apparatus according to claim 1, wherein the signal processor comprises:
a position detection processing unit configured to obtain the position information based on the first detection signal,
an eccentric error calculating unit configured to calculate an eccentric error due to the difference between the predetermined point and the rotation center of the scale based on the first detection signal, the second detection signal, the first distance, and the second distance, and
a position correcting unit configured to subtract the eccentric error calculated by the eccentric error calculating unit from the position information obtained by the position detection processing unit to obtain corrected position information.

4. The position detection apparatus according to claim 3, wherein the eccentric error calculating unit is configured to calculate the eccentric error by using the following expression:
e1=(θ1−θ2)·(r2/(r2−r1)),
where e1 is the eccentric error, θ1 is the first detection signal, θ2 is the second detection signal, r1 is the first distance, and r2 is the second distance.

5. The position detection apparatus according to claim 1, wherein the signal processor comprises:
a position detection processing unit configured to obtain the position information based on the first detection signal,
a corrected value storage unit configured to store the position information and a corrected value corresponding to the position information, and
a position correcting unit configured to obtain corrected position information based on the position information obtained by the position detection processing unit and on the corrected value stored in the corrected value storage unit.

6. The position detection apparatus according to claim 1, wherein the position detection apparatus is an absolute-type position detection apparatus.

7. The position detection apparatus according to claim 1, wherein the pattern includes a first pattern with a first period and a second pattern with a second period different from the first period.

8. The position detection apparatus according to claim 1, wherein:
the scale includes a first track and a second track,
the first detector is configured to detect the first track, and
the second detector is configured to detect the second track.

9. A lens apparatus comprising:
a lens displaceable in an optical axis direction; and
a position detection apparatus configured to detect a position of the lens, the position detection apparatus comprising:
a scale which includes a pattern circumferentially and periodically formed on a circle whose center is a predetermined point, the scale being configured to rotate depending on a displacement of the object;
a sensor unit relatively movable with respect to the scale; and
a signal processor configured to process an output signal of the sensor unit to obtain position information of the object,
wherein the sensor unit comprises:
a first detector configured to detect a first partial pattern formed in a first region apart from the predetermined point by a first distance in a radial direction on a half line starting from the predetermined point of the scale; and
a second detector configured to detect a second partial pattern formed in a second region apart from the predetermined point by a second distance different from the first distance, and
wherein the signal processor is configured to reduce an error component contained in the position information due to a difference between a rotation center of the scale and the predetermined point based on a first detection signal outputted from the first detector and on a second detection signal outputted from the second detector.

10. An image pickup system comprising:
a lens apparatus comprising:
a lens displaceable in an optical axis direction; and
a position detection apparatus configured to detect a position of the lens, the position detection apparatus comprising:
a scale which includes a pattern circumferentially and periodically formed on a circle whose center is a predetermined point, the scale being configured to rotate depending on a displacement of the object;
a sensor unit relatively movable with respect to the scale; and
a signal processor configured to process an output signal of the sensor unit to obtain position information of the object,
wherein the sensor unit comprises:
a first detector configured to detect a first partial pattern formed in a first region apart from the predetermined point by a first distance in a radial direction on a half line starting from the predetermined point of the scale; and
a second detector configured to detect a second partial pattern formed in a second region apart from the predetermined point by a second distance different from the first distance, and
wherein the signal processor is configured to reduce an error component contained in the position information due to a difference between a rotation center of the scale and the predetermined point based on a first detection signal outputted from the first detector and on a second detection signal outputted from the second detector, and
an image pickup apparatus including an image pickup element configured to perform a photoelectric conversion of an optical image formed via the lens.

11. A machine tool apparatus comprising:
a machine tool including at least one of a robot arm and a conveyer configured to convey an object to be assembled; and
a position detection apparatus configured to detect at least one of a position and an attitude of the machine tool, the position detection apparatus comprising:
a scale which includes a pattern circumferentially and periodically formed on a circle whose center is a predetermined point, the scale being configured to rotate depending on a displacement of the object;
a sensor unit relatively movable with respect to the scale; and
a signal processor configured to process an output signal of the sensor unit to obtain position information of the object,
wherein the sensor unit comprises:
a first detector configured to detect a first partial pattern formed in a first region apart from the predetermined point by a first distance in a radial direction on a half line starting from the predetermined point of the scale; and
a second detector configured to detect a second partial pattern formed in a second region apart from the predetermined point by a second distance different from the first distance, and
wherein the signal processor is configured to reduce an error component contained in the position information due to a difference between a rotation center of the scale and the predetermined point based on a first detection signal outputted from the first detector and on a second detection signal outputted from the second detector.
